(19) United States
(12) Patent Application Publication
(10) Pub. No.: US 2026/0308846 A1
(43) Pub. Date: Oct. 8, 2026

(54) Process for producing hygienized pulp

(71) Applicant: Kemira Oyj, Helsinki (FI)

(72) Inventors: Marko KOLARI, Helsinki (FI); Juhana AHOLA, Helsinki (FI); Sami PUTTONEN, Helsinki (FI)

(21) Appl. No.: 19/481,556

(22) PCT Filed: May 15, 2024
(86) PCT No.: PCT/FI2024/050233

§ 371 Date: Nov. 5, 2025

(30) Foreign Application Priority Data
May 31, 2023 (FI) 20235607

(51) Int. Cl. D21C 9/00; D21H 11/14

(52) U.S. Cl. CPC D21C 9/005; D21H 11/14

(57) ABSTRACT

There is provided a process for producing hygienized pulp. There is also provided hygienized pulp, use of the hygienized pulp in production of paper, board, molded fiber article or other fiber based articles comprising the hygienized pulp.

### TECHNICAL FIELD

The present disclosure generally relates to a process for producing hygienized pulp, and additionally to hygienized pulp.

### BACKGROUND

This section illustrates useful background information without admission of any technique described herein representative of the state of the art.

Currently hygienic board grades for food-packaging (folding board box, FBB and liquid packaging board, LPB) are most often produced from virgin fibers. Examples of such packaging are food service items, drink packages, drink service items, goods packages, goods service items and packaging items such as oven proof trays, microwave proof trays, clamshell boxes, other food boxes, soup cups, fresh meat and poultry trays, plates and cup lids.

Sustainability discussions have raised a growing interest among consumers and packaging producers to use recycled fibers.

Recycled fiber material usually contains high amounts of bacteria as well as bacterial endospores. The fiber material collected from consumers and industrial sources for recycling often contain contamination, such as food or oil residues, which provide good growth medium for bacteria. Even relatively clean looking recycled fiber material, such as collected office waste paper, usually contains high amounts of endospores as the endospore amounts are not actively monitored in production of non-hygiene/non-food packaging paper or board grades. Furthermore, the collected fiber material is often stored baled in dirty, humid and/or warm conditions that increase the risk for extensive bacterial growth. Consequently, fiber suspensions produced from recycled fiber material usually contain high amounts of bacterial contamination in form of bacteria and bacterial endospores.

If the paper or board product is intended for packaging of food or beverages, the allowable amount of bacterial endospores in the final paper and board product is strictly limited in order to avoid possible contamination of packaged materials. These limitations have caused that the use of recycled fiber material has been practically non-existent in hygienic paper and board products that have been intended for food and beverage packaging.

WO2022112663A1 relates to a method for producing paper, board, tissue and the like. In the method bacterial endospores are reduced in an aqueous fiber suspension comprising recycled cellulosic fibers having an original endospore amount of ≥10 000 CFU/ml which is reduced to an amount of ≤1000 CFU/ml by adjusting pH value to acidic value and adjusting oxidation-reduction potential (ORP) of the fiber suspension to ≥200 mV with a first oxidizing agent followed by introducing an amount of performic acid as a second oxidizing agent to the fiber suspension. The treated fiber suspension is further processed by using chemicals, such as retention agent(s), internal sizing agent(s), wet strength and/or dry strength agents commonly used in making the paper, board, tissue and the like.

There is a need for effective ways to decrease amount of bacterial endospores in aqueous fiber suspensions comprising cellulosic fibers, such as recycled cellulosic fibers in a more simpler process to produce hygienized pulp product.

### SUMMARY

The following presents a simplified summary of the features disclosed herein to provide a basic understanding of some exemplary aspects of the invention. This summary is not an extensive overview of the invention. It is not intended to identify key/critical elements of the invention or to delineate the scope of the invention. Its sole purpose is to present some concepts disclosed herein in a simplified form as a prelude to a more detailed description.

With the method according to the present invention, dry hygienized recycled pulp can be produced in one production line. Then on another production line, for example producing hygienic packaging board, functional chemistries such as strength and hydrophobation chemistries can be added to the hygienized pulp to obtain desired functional properties of the final packaging board. Pulp made of virgin fiber can be used with the hygienized recycled pulp in any suitable ratio.

In a first aspect the present invention provides a process for producing hygienized pulp, the process comprising
providing cellulosic fiber;
forming a fiber suspension having an original endospore amount of >1000 CFU/ml comprising the cellulosic fiber in a pulping stage;
removing impurities from the fiber suspension in a screening stage for producing purified fiber suspension;
subjecting the purified fiber suspension to a thickening stage; followed by
   (i) adjusting pH of the fiber suspension to a pH value of <6.5,
   (ii) adjusting the oxidation-reduction potential (ORP) of the fiber suspension to an ORP value of >200 mV with a first oxidizing agent,
   (iii) introducing an amount of performic acid as a second oxidizing agent to the fiber suspension for reducing amount of the endospores in the fiber suspension;
   forming a web of the fiber suspension on a wire; and
   pressing and drying the web for obtaining dry pulp having bacterial endospore amount <1000 CFU/g of the dry pulp, preferably <50 CFU/g of the dry pulp,
wherein the process is substantially free of using functional chemistries, such as strength chemistries and hydrophobation chemistries, preferably free of using functional chemistries, such as strength chemistries and hydrophobation chemistries.

In a second aspect the present invention provides hygienized pulp produced with the process of the present invention.

In a third aspect the present invention provides use of the hygienized pulp produced with the process of the present invention or the hygienized pulp of the present invention for producing paper, board, molded fiber based article or other fiber based articles.

In a fourth aspect the present invention provides paper, board, molded fiber based article or other fiber based articles comprising the hygienized pulp produced with the process of the present invention or the hygienized pulp of the present invention.

It has been surprisingly found that hygienized pulp, such as recycled pulp can be produced also at acidic and high conductivity process conditions with the process of the present invention. The process does not require use of any typical functional chemistries, such as strength chemistries and hydrophobation chemistries, typically used to obtain desired functionalities of ready packaging boards, thus allowing hygienized pulp, such as recycled pulp be produced also at acidic and high conductivity process conditions.

An advantage of the present invention is that instead of mild organic acids, such as citric acid, which are expensive and require higher dosage, process pH may be adjusted with a cheaper strong acids, with expected lower consumption compared to organic acids.

Additionally, centralized manufacturing of hygienized pulp, such as hygienized recycled pulp enables better management of impurities. Pulping and cleaning stages remove impurities such as plastic, styrofoam, tapes, glass, sand, metals and other non-soluble impurities. These dirty process stages will be performed in the first part of the first production line, and not disturbing the hygienic operational practices in the second production line producing the final packaging paper or board. In addition, unwanted chemical traces may be present in the recycled fiber raw materials and they may dissolve in the process water. They can be removed in this first production line, e.g., in several thickening stages before final dry hygienized pulp is formed and sent to the second production line.

The aim or goal of the process of the present invention is not at the functional properties of a final fiber based product, such as final board or paper product, which surprisingly allowed hygienized pulp, such as recycled hygienized pulp to be produced in more simpler and less chemical consuming process. The process of the present invention is also more economical as no functional chemistries is needed to be used.

A further advantage of the method of the present invention is that a typical production line originally designed for making liner board, such as recycled linerboard can be utilized in the method of the present invention by using pulping, screening and thickening stages of the production line, followed by the hygienization steps (i), (ii) and (iii).

The hygienized pulp, such as hygienized recycled pulp produced with the method of the present invention can be utilized as hygienized pulp in manufacturing of fiber based articles.

The appended claims define the scope of protection.

### BRIEF DESCRIPTION OF THE FIGURES

FIG. 1 shows a flowchart of one typical production line designed for making recycled linerboard.

FIG. 2 shows a flowchart of one exemplary production line designed for producing hygienized pulp with the process according to the present invention.

### DESCRIPTION

In first aspect the present invention provides a process for producing hygienized pulp, the process comprising
providing cellulosic fiber;
forming a fiber suspension having an original endospore amount of >1000 CFU/ml comprising the cellulosic fiber in a pulping stage;
removing impurities from the fiber suspension in a screening stage for producing purified fiber suspension;
subjecting the purified fiber suspension to a thickening stage; followed by
   (i) adjusting pH of the fiber suspension to a pH value of <6.5,
   (ii) adjusting the oxidation-reduction potential (ORP) of the fiber suspension to an ORP value of >200 mV with a first oxidizing agent,
   (iii) introducing an amount of performic acid as a second oxidizing agent to the fiber suspension for reducing amount of the endospores in the fiber suspension;
   forming a web of the fiber suspension on a wire; and
   pressing and drying the web for obtaining dry pulp having bacterial endospore amount <1000 CFU/g of the dry pulp, preferably <50 CFU/g of the dry pulp,
wherein the process is substantially free of using functional chemistries, such as strength chemistries and hydrophobation chemistries, preferably free of using functional chemistries, such as strength chemistries and hydrophobation chemistries.

Functional chemistries, i.e. agents providing functional properties or agents used to adjust functional properties of a product (paper or board), such as strength chemistries (strength agents) and hydrophobation chemistries (hydrophobation agents) are substantially not used, preferably not used in the process.

In one embodiment at the thickening stage consistency of the fiber suspension is adjusted to 1-30%, preferably 4-20%, more preferably 4-12%, even more preferably 4-10%.

In one embodiment impurities are removed in pulping section, in thickening stage, in press section and/or from process waters by a membrane cleaning system.

In one embodiment an amount of process chemistries, i.e. agents that aid the process, such as defoamer and retention agent are added to the process, preferably in mixing chest, in machine chest, or in the short loop where wet fiber web is formed in head box, excess water removed in wire section and collected to wire silo for recirculating. The amount of the process chemistries can be selected so that predetermined and/or desired effect is obtained.

In one embodiment an amount of biocide is added to the process, preferably added to shower waters of the process. The amount of the biocide can be selected so that predetermined and/or desired effect is obtained.

In one embedment the pH and the ORP are monitored and measured at the steps (i) and (ii), preferably the pH and the ORP are monitored and measured online at the steps (i) and (ii).

In one embodiment the steps (i), (ii) and (iii) are conducted at the thickening stage.

In one embodiment the steps (i), (ii) and (iii) are conducted prior a heat disperger or after a heat disperger. In one embodiment the steps (i) and (ii) are conducted prior a heat disperger and step (iii) after the heat disperger.

In one embodiment dryness the dry pulp is at least 85%, preferably at least 87%, more preferably from 87%-97%, most preferably 87%-93%.

In the present context the term “oxidation-reduction potential”, abbreviated as ORP, refers to the oxidizing or reducing potential of the aqueous fiber suspension. The ORP value for an aqueous fiber suspension may be determined by using a chemically-inert electrode which is immersed in the suspension and measuring its potential relative to a reference electrode. Several commercial sensors for ORP value measurements are available.

In the present context the term “bacterial endospore” is understood as dormant and non-reproductive structure formed by bacteria. Bacterial endospore comprises bacterium's DNA and a part of its cytoplasm encased by a protective outer covering. Bacterial endospores can germinate to the metabolically active state, i.e. vegetative state, under favourable conditions. According to one embodiment of the invention the present method is used to reduce amount of bacterial endospores of e.g. genera Bacillus, Brevibacillus and/or Paenibacillus.These genera are known to grow in the process conditions of a paper, board and tissue machines, and the like. These bacterial genera are capable of producing thermotolerant endospores, which are resistant to the heat of the dryer sections employed in processes producing cellulosic fiber webs, such as paper, board, tissue and the like.

The fiber suspension comprises a liquid phase, which is normally water, and a solid phase which comprises at least cellulosic fibers and optional inorganic particles suspended in the liquid phase. The initial aqueous fiber suspension, which is subjected to bacterial endospore reducing treatment at steps (i), (ii) and (iii) in the process of the present invention, comprises cellulosic fibers, such as recycled cellulosic fibers and it has an initial bacterial endospore amount of at least 1000 CFU/ml, typically at least 5000 CFU/ml, more typically at least 10 000 CFU/ml. The fiber suspension comprises an aqueous liquid phase and a solid phase comprising recycled fibers. The cellulosic fibers in the fiber suspension may be bleached, unbleached or a mixture bleached and unbleached fibers, such as recycled fibers. The cellulosic fibers in the fiber suspension are non-synthetic natural fibers that have been originally obtained by any mechanical or chemical pulping method or by any combination of mechanical and chemical pulping methods. The cellulosic fibers may be wood and/or non-wood fibers, preferably wood fibers, such as hardwood, softwood or any of their combination. The recycled fibers may originate from any available recycled industrial and/or consumer fiber material. The recycled fibers may originate from, for example, old corrugated containers (OCC), office waste paper, mixed office waste paper, sorted office waste paper or any mixtures thereof. The recycled fibers may originate, for example, from recycled pre-consumer fiber material and/or recycled post-consumer fiber material. The recycled fibers may even be secondary fibers from the production process of paper, board, tissue or the like, such as broke.

In one embodiment the cellulosic fiber comprises recycled cellulosic fibers. In one embodiment the cellulosic fiber consists of recycled cellulosic fibers.

In one embodiment the cellulosic fiber comprises natural cellulosic or lignocellulosic fibers originating from molded pulp products.

In one embodiment the cellulosic fiber comprises recycled cellulosic fibers, natural cellulosic or lignocellulosic fibers originating from molded pulp products or a mixture thereof.

The molded pulp products consist primarily of cellulose, lignin, and hemicelluloses. The natural fibers can be from various resources such as wood by chemical and mechanical pulping processes, recycled fibers, agriculture biomass wastes, e.g., canola straws, wheat straws, rice straw, hemp fibers, bagasse and bamboo fibers, sugar beet and a mixture thereof.

In one embodiment the recycled cellulosic fibers are sorted recycled cellulosic fibers, preferably double sorted cellulosic recycled fibers.

In one embodiment the recycled cellulosic fibers comprises old corrugated containers, sorted office waste paper, mixed waste papers and board, mixed office waste paper, mixed newspapers and magazines, used kraft, used corrugated kraft, used kraft sacks, used beverage carton, unprinted bleached sulphate board, white mechanical pulp based coated and uncoated paper, liquid board packaging, sorted office paper, new kraft, new carrier kraft, unsold magazines and newspapers, unused corrugated kraft, unused corrugating material, unused kraft sacks, recycled pre-consumer fiber material, recycled post-consumer fiber material, secondary fibers from the production process of paper, board, tissue or the like, broke, or a mixture thereof, preferably old corrugated containers, unused corrugating material, used beverage carton or a mixture thereof.

In one embodiment the amount of recycled cellulosic fibers, natural cellulosic or lignocellulosic fibers originating from molded pulp products or a mixture thereof in the fiber suspension to be treated is at least 60 weigh-%, preferably at least 80 weight-%, more preferably at least 90 weight-% or at least 95 weight-%, calculated from the total dry fiber weight of the suspension.

The aqueous fiber suspension has typically an initial oxidation-reduction (ORP) value which is negative, for example, in a range from −500 mV to −50 mV, more typically from −400 mV to −100 mV, even more typically from −300 mV to −200 mV.

In one embodiment the fiber suspension may comprise inorganic particles, such as particles of calcium carbonate, kaolin, talc, gypsum or the like. The inorganic particles usually originate from internal fillers, inorganic coatings, labels, stickers or the like, which have been present in the fiber material collected for recycling. The amount of inorganic particles, given as an ash content of the used cellulosic fiber material may be in a range of 5-30 weight-%, usually 5-25 weight-% or 10-20 weight-%. It is normally difficult and/or uneconomical to completely remove the inorganic particles from the cellulosic fiber, such as recycled fiber, material during the repulping of the fiber material, which means that usually at least some inorganic particles follow with the cellulosic fiber material, such as recycled fiber material to the fiber suspension.

The fiber suspension may usually comprise at least some dissolved carbonate ions.

The fiber suspension formed in the pulping stage comprises hydrophobic contaminants, such as plastics, tapes and/or glue residues. These contaminants, as well as other impurities, large particles, etc., are removed in one or more screening steps following the pulping stage, where contaminants and/or impurities having a size of higher than 200 micrometres are typically removed.

The fiber suspension is often subjected to fiber fractionation, where the fibers are separated according to their length to at least long fiber fraction and short fiber fraction.

In one embodiment the pH of the fiber suspension is adjusted by introducing an acidifying agent to the fiber suspension.

In one embodiment the pH of the fiber suspension is adjusted to a pH value of <6.5, preferably by introducing an acidifying agent to the fiber suspension. The pH of the fiber suspension may be adjusted within a pH range of 4-6.5, preferably 4.5-6.5, more preferably 5-6.5, even more preferably 5.5-6.3. Acidifying agent may be any chemical compound suitable for adjusting the pH value of the fiber suspension to a desired level, for example polyaluminum chloride, alum or the like. Acidifying agent may be an organic acid, such as citric acid, formic acid, or the like, or an inorganic acid, such as hydrochloric acid, sulphuric acid, or the like, or a mixture of organic acids and/or inorganic acids. The acidifying agent may be an acidifying gas, such carbon dioxide gas. When the acidifying agent is an acid in liquid form, it is added to the fiber suspension, and when the acidifying agent is in gaseous form, e.g. carbon dioxide gas, it is led into the fiber suspension. The acidifying agent is preferably introduced or added to the fiber suspension in amount that adjusts the pH of the fiber suspension to a desired pH value, without causing a significant increase in the conductivity of the fiber suspension. Effective mixing when the acidifying agent is added to the fiber suspension is advantageous.

The acidifying agent may be selected on basis of the properties, especially buffering capacity, of the fiber suspension to be treated. For example, fiber suspension with a high buffering capacity, e.g. fiber suspension comprising recycled fibers originating from sorted office waste and with a high calcium carbonate particle content, may be treated with acidifying agent(s) selected from said organic or inorganic acids or their mixtures, in order to obtain economically appropriate consumption of the acidifying agent and to avoid major pH changes which could lead to unwanted changes in conductivity of the fiber suspension.

In a preferable embodiment the conductivity of the fiber suspension does not significantly change during the reduction of the bacterial endospores in the fiber suspension according to the present process. This means that the fiber suspension usually has an initial conductivity value in a range of 2-10 mS/cm, preferably 2-7 mS/cm, measured before the pH and ORP value adjustment and the introduction of performic acid, and a final conductivity value in the range of 2-10 mS/cm, preferably 3-7 mS/cm, measured after the pH and ORP adjustments and introduction of performic acid.

In one embodiment the fiber suspension has a final conductivity value, measured after the adjustment of pH and the ORP value, in a range of 2 mS/cm-10 mS/cm, preferably 2 mS/cm-7 mS/cm

The oxidation-reduction potential (ORP) of the fiber suspension is adjusted to an ORP value of >200 mV with a first oxidizing agent, which is added or introduced to the fiber suspension. Preferably the ORP value of the fiber suspension may be adjusted to an ORP value of >250 mV, more preferably >300 mV. It has been observed that when the ORP value of the fiber suspension is adjusted to the level >200 mV, the performic acid is able to effectively eliminate and destroy the bacterial endospores present in the fiber suspension.

In one embodiment the ORP value of the fiber suspension may be adjusted to a range from +100 mV to +500 mV, preferably from +200 mV to +400 mV, more preferably from +300 mV to +400 mV.

The first oxidizing agent for adjustment of the ORP value is different from performic acid, i.e. the first oxidizing agent is not performic acid. Preferably, the used first oxidizing agent is free of performic acid. It is possible that other organic peracids than performic acid can be used as a first oxidizing agent for adjustment of the ORP value. Preferably, however, the first oxidizing agent may be hydrogen peroxide, H₂O₂, or a percarbonate salt, preferably sodium percarbonate. Hydrogen peroxide and percarbonate salts are readily available in industrial scale and they are able to effectively adjust the ORP value of the fiber suspension to the desired level. The first oxidizing agent may be considered as a sacrificial treatment agent, with which the consumption of performic acid may be kept as low as possible. The use of first oxidizing agent does provide effective means for adjusting the ORP value to a level, where the full potential of the performic acid can be realized.

In one embodiment the first oxidizing agent is H₂O₂ or a percarbonate salt.

The first oxidizing agent may be introduced to the fiber suspension in amount that provides the desired ORP value for the fiber suspension comprising cellulosic fibers. In one embodiment the first oxidizing agent may be introduced to the fiber suspension in amount of 300-1000 ppm, preferably 400-800 ppm, preferably 500 -700 ppm, given as grams active agent per m3 of fiber suspension.

The addition of the first oxidizing agent to the fiber suspension does not provide a bleaching effect for the fiber suspension. This means that the ISO brightness of the fiber suspension does not significantly change after the addition of the first oxidizing agent. In general, the change in ISO brightness of the fiber suspension, if any at all, is less than 5 ISO %, preferably less than 3 ISO %, more preferably less than 1 ISO %, measured by using standard ISO 2470-1:2016.

In one embodiment the performic acid as the second oxidizing agent is introduced, i.e. added, to the fiber suspension in amount that reduces the bacterial endospore amount to <1000 CFU/ml, preferably <500 CFU/ml, more preferably <250 CFU/ml, even more preferably <150 CFU/ml, sometimes even <100 CFU/ml, for the treated fiber suspension. In one embodiment the performic acid may be introduced to the fiber suspension in amount that reduces the bacterial endospore amount to <50 CFU/ml, even to <30 CFU/ml or even <10 CFU/ml.

In one embodiment performic acid is introduced to the fiber suspension in amount that reduces the endospore amount to <1000 CFU/gram, preferably to <50 CFU/g in the final dry hygienized pulp.

In one embodiment the performic acid may be introduced, i.e. added, to the fiber suspension in amount of 50-500 ppm, preferably 100-400 ppm, preferably 200-300 ppm, given as grams active agent per m³ of fiber suspension. Bacterial endospore amounts can be determined by using conventional techniques, known as such for a person skilled in the art.

Performic acid is introduced to the fiber suspension as an aqueous solution. Performic acid may be prepared by mixing an aqueous hydrogen peroxide solution with an aqueous solution of formic acid, and optionally a catalyst, e.g. sulfuric acid. Preferably the aqueous performic acid solution is used as an equilibrium solution comprising performic acid, formic acid, water, hydrogen peroxide and optionally a catalyst. Performic acid solution has typically a concentration at least 10 %, calculated as weight to volume, typically around 13.5 % or 14 % of performic acid, calculated as weight to volume.

Performic acid is preferably allowed to interact with the bacterial endospores in the fiber suspension at an elevated fiber suspension temperature. In one embodiment the temperature of the fiber suspension at steps (i), (ii) and (iii) is at least 20° C., such as 20-120° C., preferably at least 40° C., such as 40-50° C., more preferably at least 60° C., such as 60-100° C., even more preferably at least 65° C., such as 65-100°C. The temperature of the fiber suspension at steps (i), (ii) and (iii) may preferably be <100° C., more preferably <85° C., even more preferably <75° C. Especially, when the pH of the fiber suspension is adjusted in the range of 5.5-6.5, it is advantageous if the temperature of the fiber suspension is in a range of 30-100° C., preferably 30-99° C., more preferably 40-80° C., such as 40-50° C. even more preferably 50-80° C., when the performic acid is introduced to fiber suspension at steps (i), (ii) and (iii) and/or when the performic acid is interacting with the bacterial endospores. It has been observed that in this manner the maximal endospore destructive effect may be achieved. It is assumed, without wishing to be bound by any theory, that the elevated temperature may further sensitize the bacterial endospores and make them receptive for the destroying action when the performic acid is introduced to the fiber suspension. It is advantageous that the effective endospore reduction or destruction can be obtained already at fiber suspension temperatures below 100° C.. Expensive and complicated process devices, such as pressurized heat steam treatment tanks, can be thus avoided.

The temperature of the fiber suspension may be increased to the desired value by heating the fiber suspension to the desired temperature in a separate process step. For example, the fiber suspension may be transferred to a separate tank, located after the pulper, preferably after the screening stage(s). In the separate tank the fiber suspension may be heated to the desired temperature.

Preferably the temperature of the fiber suspension is adjusted to the elevated temperature as specified above, before the performic acid is introduced to the fiber suspension.

In one embodiment after the treatment of the fiber suspension with the performic acid at least a part of the aqueous liquid phase of the fiber suspension is separated from the solid phase of the fiber suspension comprising the cellulosic fibers and the separated aqueous liquid phase is recycled back in the process and reused for formation of the initial fiber suspension. The separated aqueous phase typically comprises a base concentration of unconsumed first and/or second oxidizing agent. This means that recirculation of the aqueous phase in the method provides a possibility to reduce the amount of the first and/or second oxidizing agent which is needed for adjustment of the ORP value to the desired level and for the destruction or reduction of bacterial endospores.

After the performic acid have been allowed to interact with the fiber suspension and the amount of bacterial endospores in the fiber suspension is reduced, the pH of the fiber suspension may be adjusted, e.g. neutralised, to a desired value by using a strong base, e.g. NaOH, or sodium bisulphite, if need be. Usually the neutralisation is performed after a suitable treatment or interaction time has elapsed after the introduction of the performic acid. The treatment time which is needed for the interaction between the performic acid and the bacterial endospores may be, for example, 5-30 min, preferably 10-15 min.

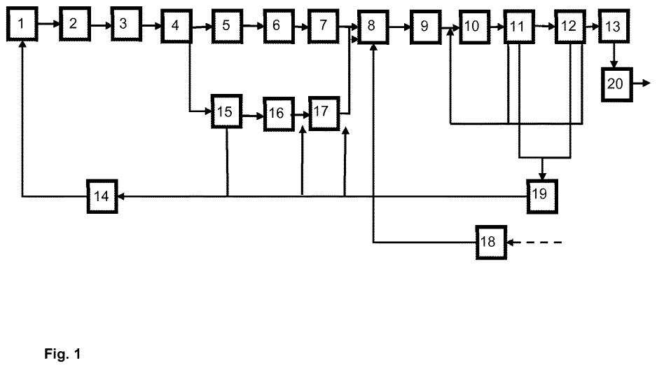

FIG. 1 shows a flowchart of one exemplary production line designed for making liner board, such as recycled linerboard. Recycled cellulosic fiber is subjected to pulping stage (1) to form a fiber suspension comprising the cellulosic fiber and the fiber suspension is transferred to dump tank (2). Impurities are removed from the fiber suspension in a screening stage (3) for producing purified fiber suspension. The purified fiber suspension is fractioned (4) to a suspension comprising long fibers and to a suspension comprising short fibers which suspensions are subjected to thickening stage (5) and (15), respectively, preferably by a disc filter. In thickening the consistency of the fiber suspension is increased, i.e. the fiber suspension is thickened to a predetermined consistency.

From the thickening stage (5, 15) the thickened suspensions are (optionally) subjected to heating in a heat disperger (6, 16), for management of the tacky hydrophobic compounds originating e.g. from glues in recycled fiber materials. The fiber suspension is directed to a storage tower (7, 17) from which the fiber suspension is transferred in a desired mixing ratio to mixing chest (8), and further to machine chest (9), and therefrom to head box (10). The head box (10) distributes the fiber suspension on a wire to form a wet fiber web, from which excess water is removed first in a wire section (11), followed by press section (12), and finally the fiber web is dried in a drying section (13). Then surface strength chemistry is added to the dried web at a size press (20) and dry recycled liner board is obtained.

Fresh water may be introduced to the system e.g. via wire, felt and roll cleaning showers at the wire section (11) and/or press section (12). Water that is drained from the wire section (11) and press section (12) can be distributed for reuse, direct after machine chest (9) or via water storages (19, 14) to multiple places in the process, including the pulper (1). Broke may be stored at a broke storage tower (18) from which broke can be delivered to the mixing chest (8).

In the production of the liner board functional chemistries, i.e. agents providing functional properties or agents used to adjust functional properties of the recycled liner board, such as strength chemistries (strength agents) and hydrophobation chemistries (hydrophobation agents) are added in wet-end, i.e. mixing chest (8) and machine chest (9), and in dry-end, i.e. size press (20).

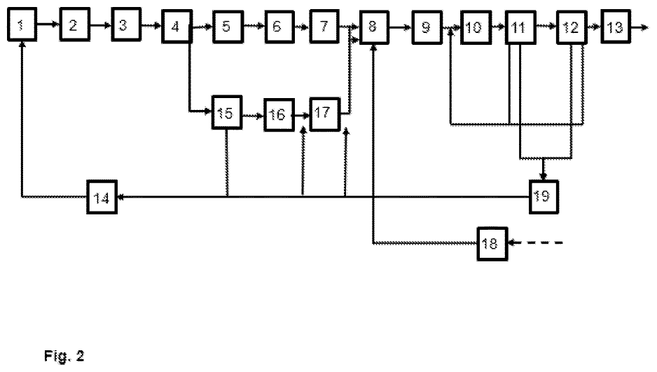

FIG. 2 shows a flowchart of one exemplary production line designed for producing hygienized pulp with the process according to the present invention. Cellulosic fiber is subjected to pulping stage (1) to form a fiber suspension comprising the cellulosic fiber and the fiber suspension is transferred to dump tank (2). Impurities are removed from the fiber suspension in a screening stage (3) for producing purified fiber suspension. The purified fiber suspension is fractioned (4) to a suspension comprising long fibers and to a suspension comprising short fibers which suspensions are subjected to thickening stage (5) and (15), respectively, preferably by a disc filter. In thickening stage consistency of the fiber suspensions is adjusted to 1-30%, preferably 4-20%, more preferably 4-12%, even more preferably 4-10%. After adjusting the consistency the fiber suspensions having high consistency is subjected to the treatment of the steps (i), (ii) and (iii).

After the treatment the treated fiber suspensions are optionally subjected to heating in a heat disperger (6, 16), for management of possible tacky hydrophobic compounds originating e.g. from glues in fiber materials, such as in recycled fiber materials. The fiber suspension is directed to a storage tower (7, 17) from which the fiber suspension is transferred in a desired mixing ratio to mixing chest (8), and further to machine chest (9), and therefrom to head box (10). The head box (10) distributes the fiber suspension on a wire to form a wet fiber web, from which excess water is removed first in a wire section (11), followed by press section (12), and finally the fiber web is dried in a drying section (13). After drying the web dry hygienized pulp is obtained. An amount of process chemistries, i.e. agents that aid the process, such as defoamer and retention agent or biocide can added to the process, in the process part beginning from the storage tower (7, 17).

Fresh water may be introduced to the system e.g. via wire, felt and roll cleaning showers at the wire section (11) and/or press section (12). Water that is drained from the wire section (11) and press section (12) can be distributed for reuse, direct after machine chest (9) or via water storages (19, 14) to multiple places in the process, including the pulper (1). Broke may be stored at a broke storage tower (18) from which broke can be delivered to the mixing chest (8).

In the process according to the present invention substantially no functional chemistries (such as strength agents and hydrophobation agents), preferably no functional chemistries are added in the wet-end, i.e. mixing chest (8) and machine chest (9), and substantially no strength chemistries, preferably no strength chemistries are applied on the dry board after the drying section (13).

In a second aspect the present invention provides hygienized pulp produced with the process of the present invention.

In one embodiment bacterial endospore amount of the hygienized pulp is <1000 CFU/g of dry pulp, preferably <50 CFU/g of dry pulp In one embodiment dryness the dry pulp is at least 85 %, preferably at least 87 %, more preferably from 87 %-97 %, most preferably 87 %-93 %.

In one embodiment the hygienized pulp comprises hygienized recycled cellulosic fibers, hygienized natural cellulosic or lignocellulosic fibers originating from molded pulp products or a mixture thereof.

In one embodiment the hygienized pulp is in a form of a reel, a sheet, or a bale of sheets.

In a third aspect the present invention provides use of the hygienized pulp produced with the process of the present invention or the hygienized pulp of the present invention for producing paper, board, molded fiber based article or other fiber based articles in another production line.

In one embodiment the hygienized pulp comprises hygienized recycled cellulosic fibers, hygienized natural cellulosic or lignocellulosic fibers originating from molded pulp products or a mixture thereof

The hygienized pulp may be used to produce any fiber based article where hygienic fiber pulp is required. The hygienized pulp may be used with virgin fiber in any suitable ratio.

In a fourth aspect the present invention provides paper, board, molded fiber based article or other fiber based articles comprising the hygienized pulp produced with the process of the present invention or the hygienized pulp of the present invention.

In one embodiment the hygienized pulp comprises hygienized recycled cellulosic fibers, hygienized natural cellulosic or lignocellulosic fibers originating from molded pulp products or a mixture thereof

The fiber based article may be food-packaging (folding board box, FBB) and liquid packaging board, LPB). Examples of such packaging are food service items, drink packages, drink service items, goods packages, goods service items and packaging items such as oven proof trays, microwave proof trays, clamshell boxes, other food boxes, soup cups, fresh meat and poultry trays, plates and cup lids.

Various embodiments have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A process for producing hygienized pulp, the process comprising providing cellulosic fiber;
forming a fiber suspension having an original endospore amount of >1000 CFU/ml comprising the cellulosic fiber in a pulping stage;
removing impurities from the fiber suspension in a screening stage for producing purified fiber suspension;
subjecting the purified fiber suspension to a thickening stage; followed by
(i) adjusting pH of the fiber suspension to a pH value of <6.5,
(ii) adjusting the oxidation-reduction potential (ORP) of the fiber suspension to an ORP value of >200 m V with a first oxidizing agent,
(iii) introducing an amount of performic acid as a second oxidizing agent to the fiber suspension for reducing amount of the endospores in the fiber suspension;
forming a web of the fiber suspension on a wire, and
pressing and drying the web for obtaining dry pulp having bacterial endospore amount <1000 CFU/g of the dry pulp, preferably <50 CFU/g of the dry pulp,
wherein the process is substantially free of using functional chemistries, such as strength chemistries and hydrophobation chemistries, preferably free of using functional chemistries, such as strength chemistries and hydrophobation chemistries.

2. The process according to claim 1, wherein the cellulosic fiber comprises recycled cellulosic fibers, natural cellulosic or lignocellulosic fibers originating from molded pulp products or a mixture thereof.

3. The process according to claim 1, wherein at the thickening stage consistency of the fiber suspension is adjusted to 1-30%, preferably 4-20%, more preferably 4-12%, even more preferably 4-10%.

4. The process according to claim 1, wherein impurities are removed in pulping section, in thickening stage, in press section and/or from process waters by a membrane cleaning system.

5. The process according to claim 1, wherein an amount of process chemistries, such as defoamer and retention agent and/or biocide are added in mixing chest, in machine chest, or in the short loop where wet fiber web is formed in head box, excess water removed in wire section and collected to wire silo for recirculating.

6. The process according to claim 1, wherein the pH and the ORP are monitored and measured at the steps (i) and (ii), preferably the pH and the ORP are monitored and measured online at the steps (i) and (ii).

7. The process according to claim 1, wherein the steps (i), (ii) and (iii) are conducted at the thickening stage.

8. The process according to claim 1, wherein dryness the dry pulp is at least 85%, preferably at least 87%, more preferably from 87%-97%, most preferably 87%-93%.

9. The process according to claim 1, wherein the fiber suspension comprises inorganic particles, such as calcium carbonate particles, and the pH of the fiber suspension is adjusted to a range of 5-6.5, more preferably 5.5-6.5, even more preferably 6-6.5.

10. The process according to claim 1, wherein the temperature of the fiber suspension at steps (i), (ii) and (iii) is at least 20° C., preferably at least 40° C., such as 40-50° C., more preferably at least 60° C., even more preferably at least 65° C.

11. The process according to claim 1, wherein the fiber suspension has a final conductivity value, measured after the adjustment of pH and the ORP value, in a range of 2 mS/cm-10 mS/cm, preferably 3 mS/cm-7 mS/cm.

12. The process according to claim 1, wherein ORP value is adjusted to a range from +100 mV to +500 mV, preferably from +200 mV to +400 m V, more preferably from +300 m V to +400 mV.

13. Hygienized pulp produced with the process according to claim 1.

14. (canceled)

15. Paper, board, molded fiber based article or other fiber based articles comprising the hygienized pulp produced with the process of according to claim 1.

16. The process according to claim 2, wherein at the thickening stage consistency of the fiber suspension is adjusted to 1-30%, preferably 4-20%, more preferably 4-12%, even more preferably 4-10%.

17. The process according to claim 2, wherein impurities are removed in pulping section, in thickening stage, in press section and/or from process waters by a membrane cleaning system.

18. The process according to claim 3, wherein impurities are removed in pulping section, in thickening stage, in press section and/or from process waters by a membrane cleaning system.

19. The process according to claim 2, wherein an amount of process chemistries, such as defoamer and retention agent and/or biocide are added in mixing chest, in machine chest, or in the short loop where wet fiber web is formed in head box, excess water removed in wire section and collected to wire silo for recirculating.

20. The process according to claim 3, wherein an amount of process chemistries, such as defoamer and retention agent and/or biocide are added in mixing chest, in machine chest, or in the short loop where wet fiber web is formed in head box, excess water removed in wire section and collected to wire silo for recirculating.
